(19) United States
(12) Patent Application Publication
(10) Pub. No.: US 2004/0144031 A1
(43) Pub. Date: Jul. 29, 2004

(54) Garage door opener and a bracket for a garage door opener

(76) Inventor: Miguel Angel Ferreyra, Stafford, VA (US)

Correspondence Address: Miguel A. Ferreyra, 3 St. John's Court, Stafford, VA, 22554, US

(21) Appl. No.: 10/352,427

(22) Filed: Jan. 29, 2003

(51) Int. Cl. E05D 15/02

(52) U.S. Cl. 49/95

(57) ABSTRACT

The invention relates to a bracket adapted to form the connection between a conventional ¼-½ horsepower garage door opener to a pair of conventional side-by-side garage doors. Garage doors in accordance with this invention consist of hingedly connected segments having rollers and a pair of roller tracks on which the rollers and thus the door segments slide. My bracket has a flange connected to each door, legs and a base portion adapted to span the tracks of adjacent garage doors and a central portion spanning the distance between adjacent garage doors and connected to the movable carriage of a conventional garage door opener in order to permit a single door opener to operate both doors simultaneously. Brackets in accordance with this invention may have a W-shape and be constructed from a series of smaller sections. The size and shape of this W permits each outer flange of the W to be connected to a separate one of the doors while the center of the W is connected to the carriage of a conventional garage door opener. A series of holes in the bracket sections together with connecting bolts permits the size and shape of the bracket to be varied for differently sized tracks and differently spaced garage doors.

### BACKGROUND OF THE INVENTION

1. Field of the Invention

The invention relates to the art of garage door openers. In today's economy with both husband and wife working most households own at least two cars, and accordingly when a two-car family looks for a house they will want a two-car garage. In most new home construction the new two car garage does not come equipped with automatic garage door openers, and providing such automatic garage door openers for both doors involve considerable expense not only because of the cost of the two openers required but also because of the labor of installation which may exceed the cost of the openers themselves.

2. Description of Related Art

The conventional garage doors consist of a plurality of hingedly connected segment, and the hinge which connects the segments usually includes a hinge pin and a roller adapted to roll in one of a pair of tracks mounted along each side of the door. In order to assist in the opening process a pair of springs may be provided as in U.S. Pat. Nos. 5,934.019; 6,046,562 and/or 6,134,853 to support the weight of the door as it opens and closes. Openers for these doors are usually one of two basic types. The first has a screw driven carriage attached to the door and a reversible motor drives the screw first in one direction to open the door and then in the opposite direction to close the door.

A second type of garage door opener has a carriage attached to one side of a continuous chain. The chain is driven by a motor driven sprocket in one direction to close and in another direction to open the garage door.

The current practice is to place doors in side-by-side relationship and provide a separate radio controlled garage door opener for each door or alternatively to provide one gigantic door as shown in U.S. Pat. No. 2,285,110 adapted to open and close both sections of the garage.

### SUMMARY OF THE INVENTION

My invention is adapted for used with any pair of the track-supported doors in order to allow them both to be operated by a single radio controlled garage door opener. According to conventional construction practice garage doors are spaced by a predetermined distance. A support member and a very short wall are provided between the doors. The width of the short wall determines the space between parked cars in the garage.

My invention relates to a bracket, which attaches to and connects the two side-by-side doors to permit them to be operated by one single conventional garage door opener. To do this my bracket has a pair or attachment flanges on opposite edges, a pair of U-shaped portions dimensioned to bridge the tracks, the rollers and the biasing spring, and a connecting portion dimensioned to span the distance between adjacent tracks and to be connected to the common garage door opener.

Although many shapes and configurations of brackets are contemplated the simplest is a W-shaped device designed for standard garage door pairs where outer legs of the W- have attachment flanges for attachment to the adjacent doors, the trough portions of the W- are dimensioned to span the adjacent tracks of the two garage doors and the central portion of the W-spans the short wall between doors and provides an attachment means for the garage door opener.

### BRIEF DESCRIPTION OF THE DRAWINGS

FIG. 1 is a pair of garage doors in accordance with this invention showing a two-part bracket and central portion of variable length connected to a conventional garage door opener. Portions of the tracks have been removed for clarity.

FIG. 2 back view or the garage pair of FIG. I with the opener apparatus removed to better show the bracket.

FIG. 3 is a perspective view of an adjustable W-shaped bracket.

### DESCRIPTION OF THE PREFERRED EMBODIMENT

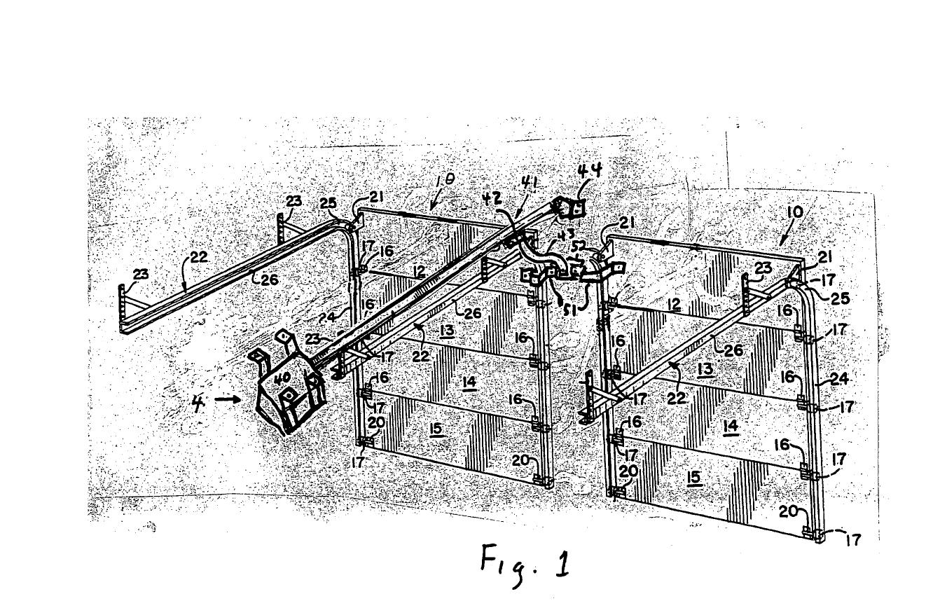

Garage door systems in accordance with this invention consist of two side-by-side doors 10. The doors 10 are usually identical but they do not have to be. For purposes of this description I have shown them as being identical and the following description applies to both doors. As shown in FIG. 1 each door 10 consists of a plurality of segments 12, 13, 14 and 15. Hinges 16 having rollers 17 mounted on their respective hinge pins connect these segments together. At the bottom and top of the door are terminal roller mounting brackets 20 and 21. Often the lower roller mounting bracket includes an attachment means for a spring loaded cable to help support the weight of the garage doors as they open and close, but for simplicity I have shown neither the springs nor the cables.

Along each side of the door is a track 20, which is normally, formed in three parts 24, 25, and 26. The lower part 24 is connected to the walls by brackets, which are not shown. The upper part is connected to the ceiling by adjustable brackets 23.

In prior art arrangements a garage door opener 4 would be provided for each door, but in accordance with my invention a single opening device 4 is provided between adjacent doors. The opening device 4 includes a motor 40, and a housing and drive train 41, which extend parallel to track segments 26. A bracket 44 connects the far end of the housing and drive train to the wall between adjacent doors, and a power driven carriage 42 drags connecting arm 43 back and forth along the housing and drive train 41. It should be noted that the drive train which is not shown in detail may be a screw or a sprocket driven chain or any other drive means capable of moving carriage 42 back and forth between the wall and the motor 40. The track segment 26 from the right hand door has been removed to show details of the carriage and the bracket device.

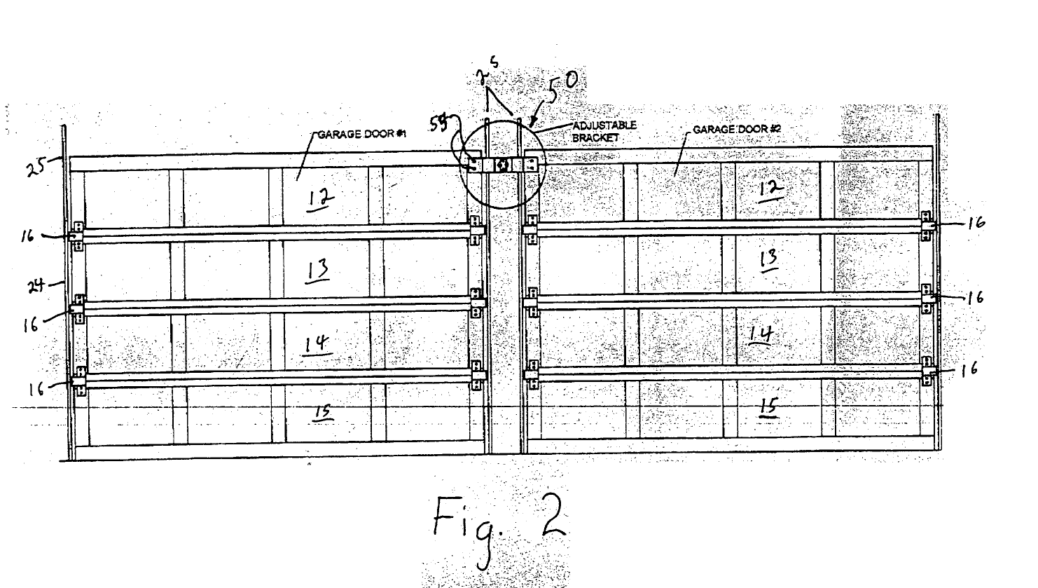

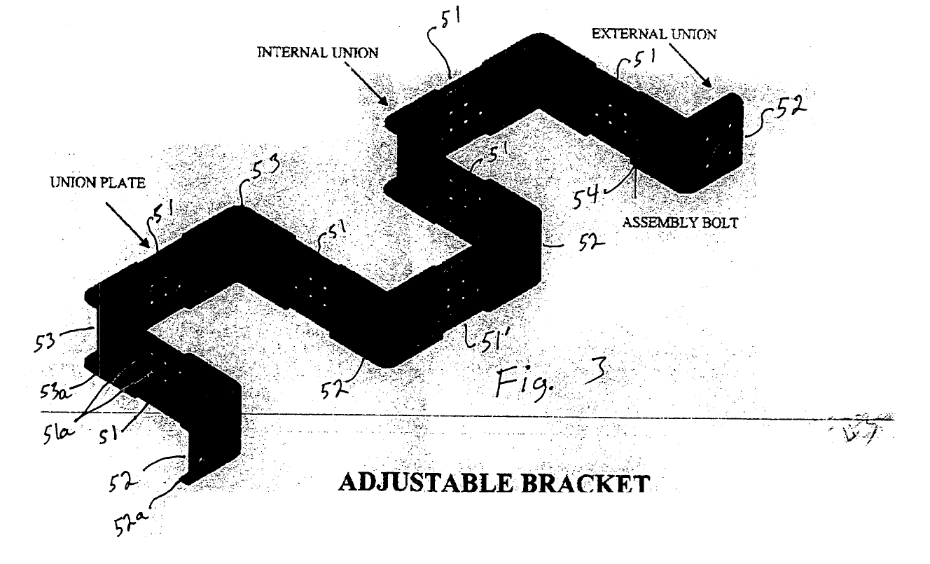

My invention as shown in FIGS. 1-3 comprises a sectional and adjustable bracket 50 having straight bracket sections 51 and 51′, inside corner sections 52 and outside corner sections 53. Each straight bracket section 51 has a series of holes 51a making them adjustable for different garage door track systems. As seen in FIG. 3 straight bracket section 51′ is shown as being identical to straight sections 51, but when provided in kit form bracket 51′ must correspond to a wide range of wall sizes. So in practice bracket section 51′ is provided as a long section, which may be cut to proper length with a hacksaw or it may be a series of plates allowing a purchaser to simply select the proper length. All inside corner sections 52 have inwardly directed flanges 52a and outside corner sections 53 have outwardly directed flanges 53a, which reinforce the respective corner sections and make the resulting brackets robust enough to support a pair of garage doors. Brackets in accordance with this invention are adapted to be connected to a ¼-½ horsepower garage door opener and to support the weight of both garage doors during the opening and closing process. The outermost corner sections 52 are adapted to be connected to the upper most door segment 12. The bracket further includes two U-shaped portions dimensioned to span the tracks 22 and transfer load from the garage door opener to each of the adjacent doors. Multiple holes may be provided in corner sections 52 and 53 together with bolts 54 to make the U-shaped portions adjustable for different track sizes 22.

Activation of the radio-controlled motor 40 will cause the carriage to move from right to left to open both garage doors. Activation of the motor in the opposite direction will cause the carriage to move from left to right to close the garage doors.

Various changes and alterations may be made in the invention as disclosed with out departing from the scope and spirit of the invention. For example, the bracket may be a single U-shape instead of the W- shape as shown. As shown, when the opener is used with identically sized doors, the opener is mounted on a central point on the W-shape. In recent times however, it has become common practice to provide a large and small garage door. In this situation the single garage door opener would be mounted at the balancing point of the two doors (Usually closer to the larger and heavier door). Many other changes and modifications will occur to those skilled in the art of garage door openers the scope of this invention being solely limited by the scope of the accompanying claims.

I claim:

1. A garage door system for use with a pair of adjacent operable garage doors having a predetermined spacing said system being adapted to open both doors with a single motor, said system comprising an electric motor, a housing and drive means, and a carriage which is movable along said housing when said motor is activated the improvement comprising, said garage door opener being adapted for mounting between said adjacent garage doors and a bracket adapted to be attached to said doors and to span the distance between said doors, said movable carriage being attachable to said bracket in such a way as to operate both doors simultaneously.

2. A system as in claim 1 wherein said garage doors slide on parallel tracks and said garage door bracket is dimensioned to span said tracks and the distance between said garage doors.

3. A system as in claim 1 wherein said garage doors slide on parallel tracks and said bracket comprises a first pair of flanges adapted for attachment to adjacent doors a pair of U-shaped portions adapted to span adjacent tracks, and a connecting portion adapted to span the distance between the U-shaped parts and be connected to the movable carriage of the garage door opener.

4. A system as in claim 3 wherein the bracket is made from a series of bracket sections including inside corner sections, outside corner sections and straight sections all being connectable in an adjustable manner to allow said bracket to fit a multiplicity of differently sized garage door tracks and garage door spacing.

5. A bracket adapted for attachment to a pair of spaced adjacent garage doors and to a movable carriage on a garage door opener in order to permit two adjacent doors to be operated by a single garage door opener having a movable carriage, said bracket having a first and second attachment means adapted to be attached to each of the adjacent garage doors, and a central portion adapted to span the distance between adjacent garage doors and be connected to the movable carriage of the garage door opener.

6. A bracket as in claim 5 wherein said garage doors open and close by moving along spaced parallel tracks, said adjacent doors having adjacent tracks, and wherein said bracket further comprises at least one U-shaped spanning segment for spanning said adjacent tracks, and a central portion adapted to be attached to said movable carriage.

7. A bracket as in claim 6 wherein said bracket is formed from a series of bracket sections including inside corner sections, outside corner sections and straight sections all being connectable in an adjustable manner to allow said bracket to fit a multiplicity of differently sized garage door tracks and garage door spacing.

8. A bracket as in claim 7 wherein one of said straight sections is much longer than the other straight sections and adapted to be cut to length in order to span the distance between said first and second garage doors.
